(19) United States
(12) Patent Application Publication
(10) Pub. No.: US 2009/0127114 A1
(43) Pub. Date: May 21, 2009

(54) MULTI-CHANNEL CAPILLARY ELECTROPHORESIS MICROCHIPS AND USES THEREOF

(76) Inventors: Min Guo, Beijing (CN); Guibin Du, Beijing (CN); Guangsheng Gu, Beijing (JP); Wanli Xing, Beijing (CN); Jing Cheng, Beijing (JP)

Correspondence Address: MORRISON & FOERSTER LLP, 12531 HIGH BLUFF DRIVE, SUITE 100, SAN DIEGO, CA, 92130-2040, US

(21) Appl. No.: 12/158,489

(22) PCT Filed: Dec. 22, 2006
(86) PCT No.: PCT/CN2006/003541

§ 371 Date: Sep. 22, 2008

(30) Foreign Application Priority Data
Dec. 31, 2005 (CN) 200510135476.7

(51) Int. Cl. G01N 27/447

(52) U.S. Cl. 204/451; 204/601

(57) ABSTRACT

A multi-channel capillary electrophoresis microchip for analysis of multiple samples comprising: at least two sample reservoirs, at least two sample channels corresponding to said sample reservoirs, a sample buffer reservoir, a sample waste reservoir, a separation buffer reservoir, a separation waste reservoir, a sample loading channel, and a separation channel, wherein each of said sample channels is connected at one end to said sample loading channel at a place between said sample buffer reservoir and said intersection of said sample loading channel and said separation channel, and the other end of each of said sample channels is connected to each of said sample reservoirs. A method of capillary electrophoresis separation for sequentially analysis of multiple samples.

### CROSS-REFERENCE TO RELATED APPLICATIONS

This application claims priority from Chinese patent application 200510135476.7, filed Dec. 31, 2005. The contents of this document are incorporated herein by reference.

### TECHNICAL FIELD

The present invention relates to multi-channeled capillary electrophoresis microchips and electric potential control methods.

### BACKGROUND OF THE INVENTION

Capillary electrophoresis microchips (CE-chips) are built upon the basic principles and techniques of capillary electrophoresis by using microfabrication technologies to form onto the surface of silica, glass, or polymeric materials various functional microstructures, such as flow channels, reaction cells, electrodes, and so on. Various tasks can be performed on the microchips, including, sample loading, separation, and detection. CE-chips provide several advantages compared to conventional capillary electrophoresis system.

(1). High-Efficiency Assays

CE-chips' high efficiency is demonstrated primarily by: (1) excellent separation effect; (2) fast speed; and (3) low consumption of sample materials. These advantages are the results of microstructures on CE-chips. On the one hand, the microfabricated channels have small cross sectional areas and high surface-to-volume ratios, which lead to an excellent heat dissipation effect so that higher electric potentials may be applied to get better resolutions and faster speeds for separations. On the other hand, the size of the microstructures on CE-chips being in the range of microns, sample consumption for each assay is very small, and efficiency in terms of material usage is also increased.

(2). Flexible Chip Designs

With available microfabrication technologies, a variety of microchannels, functional elements, and microstructures can be formed on chips, leading to many different types of CE-chips that greatly increases their applications and performances. For instance, a single chip with 96 or even 384 separation channels have been fabricated, increasing the assay throughput tremendously. A 2-dimensional electrophoresis can be accomplished on the chip to further enhance the separation effect. These designs are, however, difficult to be implemented with technologies using conventional capillary electrophoresis.

(3). Readiness for Integration

A salient feature of CE-chips is that they can be easily integrated with other devices or instruments. For example, they can be used as efficient detection tools in Lab-On-a-Chip systems. If connected with a PCR chip, a CE-chip is able to detect nucleic acids amplifications. In addition, when coupled with appropriate interfaces, a CE-chip may be attached to other devices, such as a mass spectrometer to automate complicated assay processes. Integration with other systems is one of the major directions for further developing CE-chips in the future.

U.S. Pat. No. 6,749,734 discloses microfabricated capillary array electrophoresis devices with an array of separation channels connected to an array of sample reservoirs.

All references, publications, and patent applications disclosed herein are hereby incorporated by reference in their entirety.

### SUMMARY OF THE INVENTION

One objective of the present invention is to provide a new multi-channeled capillary electrophoresis microchip (CE-chip), which has a higher assay throughput compared to conventional CE-chips.

Yet another objective of the present invention is to provide an electric potential control method associated with the multi-channeled CE-chip. Using the method, contaminations between multiple channels are prevented, and multiple samples can be independently and sequentially separated by capillary electrophoresis.

In one aspect, the present invention provides a multi-channel capillary electrophoresis microchip comprising: at least two sample reservoirs, at least two sample channels corresponding to said sample reservoirs, a sample buffer reservoir, a sample waste reservoir, a separation buffer reservoir, a separation waste reservoir, a sample loading channel, and a separation channel, wherein said sample loading channel is connected to said separation channel by crossing at an intersection; wherein said sample loading channel has two ends, one end being connected to said sample buffer reservoir, the other end being connected to said sample waste reservoir; wherein said separation channel has two ends, one end being connected to said separation buffer reservoir, and the other end being connected to said separation waste reservoir; and wherein each of said sample channels is connected at one end to said sample loading channel at a place between said sample buffer reservoir and said intersection of said sample loading channel and said separation channel, and the other end of each of said sample channels is connected to each of said sample reservoirs.

In another aspect, the invention provides a method of capillary electrophoresis separation for sequentially analysis of multiple samples, said method comprising: (a) providing a multi-channel capillary electrophoresis microchip described herein, wherein said sample reservoirs are filled with samples; (b) loading a sample from its corresponding sample reservoir to said sample waste reservoir by applying electric potentials, while other samples remain in their corresponding sample reservoirs; (c) retracting the portion of the sample in step (b) outside said intersection of said sample loading channel and said separation channel back to said corresponding sample reservoir and said sample waste reservoir by applying electric potentials, while the portion of the sample inside said intersection remains in said separation channel and other samples remain in their corresponding sample reservoirs; and (d) electrophoretically separating the portion of the sample inside said intersection in step (c) by applying electric potentials to migrate the portion of the sample to said separation waste reservoir, while other samples remain in their corresponding sample reservoirs. In some embodiments, the steps (b) to (d) are repeated for a second sample.

### BRIEF DESCRIPTION OF THE DRAWINGS

FIG. 1 is an overview of a CE-chip microchannels.

FIG. 2 shows a sample loading process using the CE-chip.

FIG. 3 shows a sample retraction process using the CE-chip.

FIG. 4 shows a sample separation process using the CE-chip.

### MODES OF CARRYING OUT THE INVENTION

The invention provides multi-channel capillary electrophoresis microchips and electric potential control methods to use the microchips. The microchip comprises: at least two sample reservoirs, at least two sample channels, a sample buffer reservoir, a sample waste reservoir, a separation buffer reservoir, a separation waste reservoir, a sample loading channel, and a separation channel. The sample loading channel is connected to the separation channel by crossing at an intersection. The sample loading channel has two ends, one end being connected to the sample buffer reservoir, the other end being connected to the sample waste reservoir. The separation channel has two ends, one end being connected to the separation buffer reservoir, the other end being connected to the separation waste reservoir. The sample channels are connected to the sample loading channel somewhere between the intersection and the sample buffer reservoir. Each of the sample channels having an end that is connected to a sample reservoir.

The microchip may have at least three, at least four, at least five, or at least six sample reservoirs and corresponding sample channels. The sample reservoirs may have a diameter ranging from 0.1 mm to 10 mm.

The cross section of any of the channels (including the sample channels, the sample loading channel, and the separation channel) may be in a shape of a circle, an ellipsoid, a rectangle, a triangle, a hexagon, an octagon, or a ring. The cross section of the sample channels, the sample loading channel, and the separation channel can be in different shapes. The channels may be in straight line, a line composed of several straight segments, a curved line, or a combination thereof. The length of the channels may vary from 100 μm to 10 m.

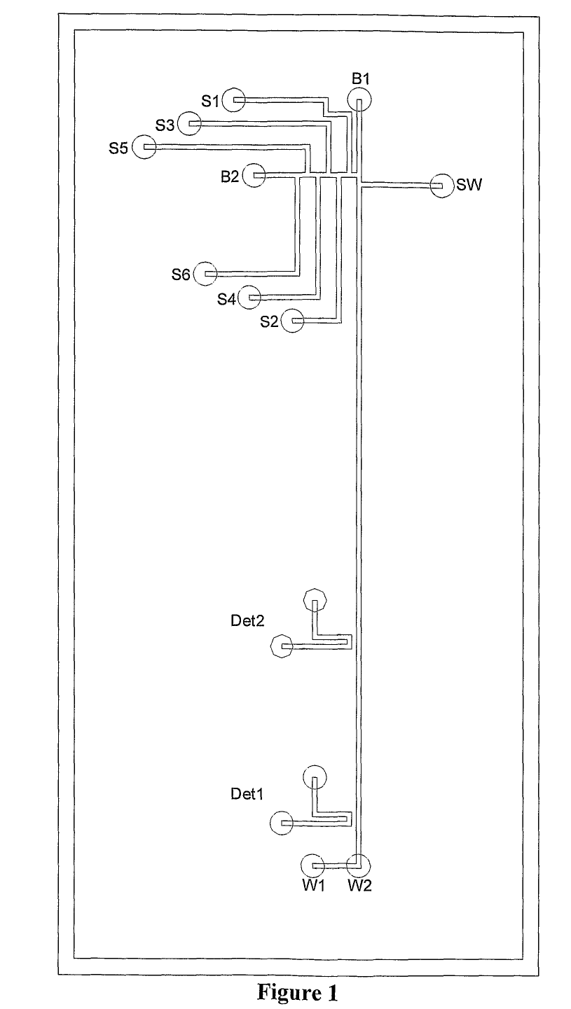

In some embodiments, the sample loading channel is a straight cross with the separation channel. In some embodiments, the sample loading channel overlaps a portion with the separation channel. See, e.g., FIG. 1. The volume of the portion is related to the amount of sample being electrophoretically separated in the separation channel.

The microchips described herein may be fabricated in various ways using a wide variety of materials. For example, glass, silicon, polymer, or any combination thereof may be used. Various techniques, such as micro-etching, hot embossing, injection molding, mechanical machining, or any combination thereof, may be used to fashion the microchips. Attachment techniques (e.g., thermal, chemical, light-activated bonding, and mechanical attachment) may also be used if more than one layer of materials need to be assembled together.

Electrodes may be built into the chip. These electrodes are directly connected to the reservoirs. Alternatively, these electrodes may be inserted into the reservoirs.

To use the microchip for capillary electrophoresis analysis of multiple samples, these samples are first loaded into the reservoirs. Different combinations of electric potentials are then applied at the sample buffer reservoir, the sample waste reservoir, the separation buffer reservoir, the separation waste reservoir, and the sample reservoirs, for loading, retracting, and separating one sample at a time, respectively.

The electric potential control method comprises three steps corresponding to sample loading, sample retracting, and sample separation, respectively. The sample loading is referring to a process in which, by an electric field resulted from a combination of electric potentials applied at those reservoirs, a sample is driven from corresponding sample reservoir to sample waste reservoir, while other samples remained at their sample reservoirs. The sample retracting is referring to a process in which, by an electric field resulted from a different combination of electric potentials, the portion of a loaded sample outside of the intersection between the sample loading channel and the separation channel is driven back from the sample loading channel to its corresponding sample reservoir as well as the sample waste reservoir, and the portion of the loaded sample inside of the intersection is driven to downstream of the separation channel, while other samples remain in their sample reservoirs. The sample separating is referring to a process in which, by an electric field resulted from yet another combination of electric potentials, a sample is driven in the separation channel to the separation waste reservoir, while other samples being prevented from diffusing out of their respective sample reservoirs.

Voltage from −106 V to +106 V may be applied between any of two reservoirs. Either positive or negative potentials may be applied, depending on the electric charges of the molecules to be analyzed in the samples.

It should be noted that, as used herein, the singular form “a”, “an”, and “the” includes plural references unless indicated otherwise.

The following is an example of a multi-channeled CE-chip design. It is provided to illustrate, but not to limit, the invention.

(1) Design of a Multi-Channeled CE-Chip

Consider multiple channels as a network of effective electric resistances. By a simulation of electric currents through the resistance network, the appropriate combinations of electric potentials can be determined. FIG. 1 illustrates an example of a multi-channeled CE-chip design. In FIG. 1, S1, S2, S3, S4, S5, and S6 represent sample reservoirs; B1 represents separation buffer reservoir; B2 represent sample buffer reservoir; SW represents sample waste reservoir; W1 and W2 represents separation waste reservoir; B2—SW represents sample loading channel; B1—W1 represents separation channel; the channels between S1-S6 and the sample loading channel represent six sample channels; and Det1 and Det2 represent two detection points.

(2). Sample Flow Direction During Sample Loading Process

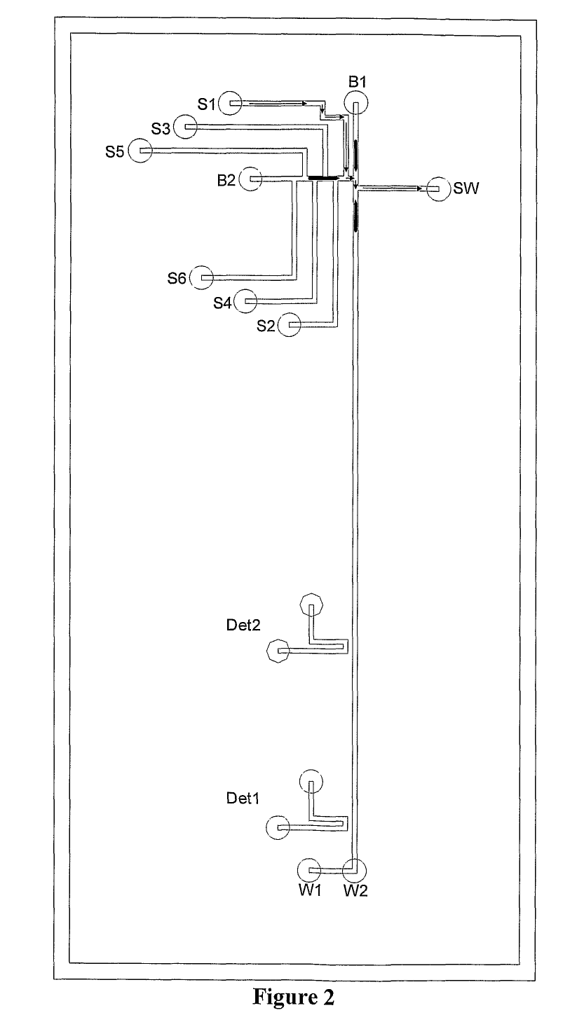

A sample flow direction for loading a sample in reservoir S1 is illustrated in FIG. 2, where solid lines denote the actual sample flow paths and directions, and broken lines denote virtual sample flow paths and directions as dictated by the corresponding electric field applied. Because of the applied electric field, there are no sample flows in the microchannels shown with the broken lines.

(3). Sample Flow Direction During Sample Retracting Process

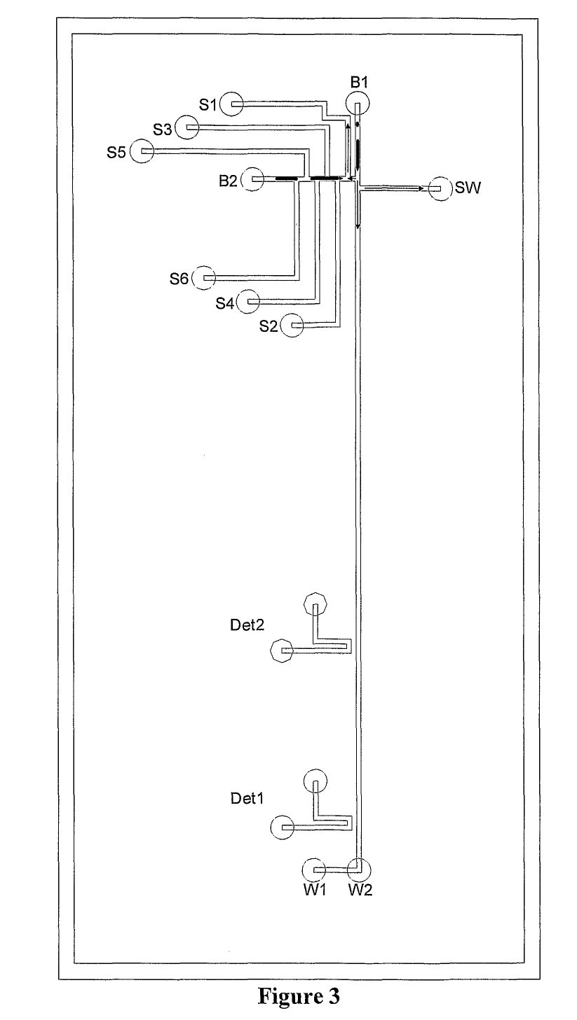

The sample flow direction for sample retraction is illustrated in FIG. 3, where solid lines denote the actual sample flow paths and directions, and broken lines denote virtual sample flow paths and directions as dictated by corresponding electric field applied. Because of the applied electric field, there are no real sample flows in the microchannels shown with the broken lines.

(4). Sample Flow Direction During Sample Separation Process

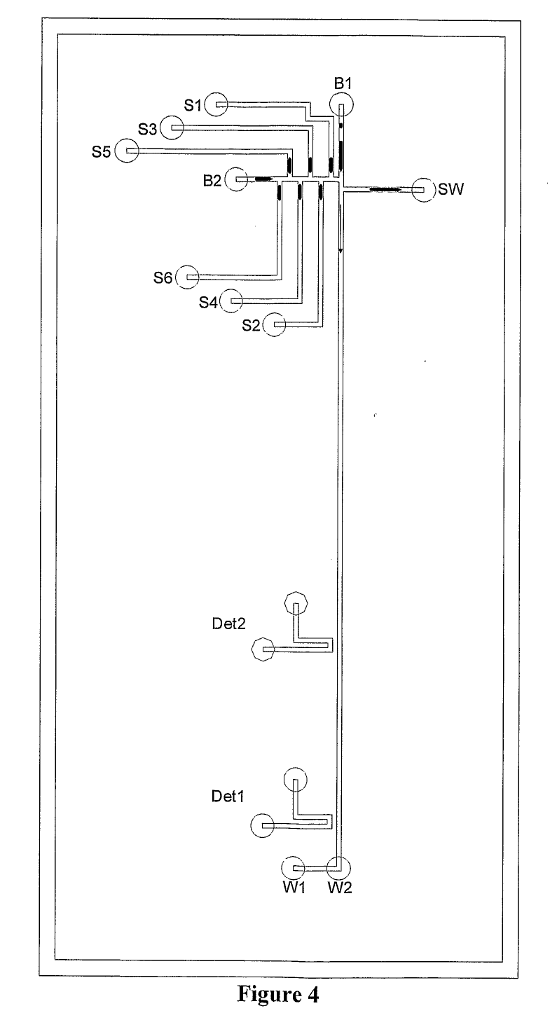

The sample flow direction for sample separation is illustrated in FIG. 4, where solid lines denote the actual sample flow paths and directions, and broken lines denote virtual sample flow paths and directions as dictated by the corresponding electric field. Because of the applied electric field, there are no real sample flows in the microchannels shown with the broken lines.

Although the foregoing invention has been described in some detail by way of illustration and example for purposes of clarity and understanding, it will be apparent to those skilled in the art that certain changes and modifications may be practiced. Therefore, descriptions and examples should not be construed as limiting the scope of the invention, which is delineated by the appended claims.

1. A multi-channel capillary electrophoresis microchip for analysis of multiple samples comprising:
at lest two sample reservoirs, at least two sample channels corresponding to said sample reservoirs, a sample buffer reservoir, a sample waste reservoir, a separation buffer reservoir, a separation waste reservoir, a sample loading channel, and a separation channel,
wherein said sample loading channel is connected to said separation channel by crossing at an intersection;
wherein said sample loading channel has two ends, one end being connected to said sample buffer reservoir, the other end being connected to said sample waste reservoir;
wherein said separation channel has two ends, one end being connected to said separation buffer reservoir, the other end being connected to said separation waste reservoir; and
wherein each of said sample channels is connected at one end to said sample loading channel at a place between said sample buffer reservoir and said intersection of said sample loading channel and said separation channel, and the other end of each of said sample channels is connected to each of said sample reservoirs.

2. The microchip of claim 1, the material used for fabrication of the microchip is glass, silica, polymers, or any combination thereof.

3. The microchip of claim 1, which is fabricated by micro-etching, hot embossing, injection molding, mechanical machining, or any combination thereof.

4. The microchip of claim 1, wherein each of said sample reservoirs has a diameter of 0.1 mm to 10 mm.

5. The microchip of claim 1, further comprises electrodes connected to the reservoirs.

6. The microchip of claim 1, wherein the cross section of said sample channels is in a shape of a circle, an ellipsoid, a rectangle, a triangle, a hexagon, an octagon, or a ring.

7. The microchip of claim 1, wherein the cross section of said sample loading channel is in a shape of a circle, an ellipsoid, a rectangle, a triangle, a hexagon, an octagon, or a ring.

8. The microchip of claim 1, wherein the cross section of said separation channel is in a shape of a circle, an ellipsoid, a rectangle, a triangle, a hexagon, an octagon, or a ring.

9. The microchip of claim 6, wherein said cross section has an area of from 1.0 mm² to 0.01 μm².

10. The microchip of claim 1, wherein said sample channels are a straight line, a line composed of several straight segments, a curved line, or a continuation thereof.

11. The microchip of claim 1, wherein each of said sample channels has a length of 100 μm to 10 m.

12. The microchip of claim 1, wherein said sample loading channel is a straight line, a line composed of several straight segments, a curved line, or a combination thereof.

13. The microchip of claim 1, wherein said sample loading channel has a length of 100 μm to 10 m.

14. The microchip of claim 1, wherein said separation channel is a straight line, a line composed of several straight segments, a curved lien, or a combination thereof.

15. The microchip of claim 1, wherein said separation channel has a length of 100 μm to 10 m.

16. A method of capillary electrophoresis separation for sequentially analysis of multiple samples, said method comprising:
(a) providing a multi-channel capillary electrophoresis microchip according to claim 1, wherein said sample reservoirs are filled with samples;
(b) loading a sample from its corresponding sample reservoir to said sample waste reservoir by applying electric potentials, wile other samples remain in their corresponding sample reservoirs;
(c) retracting the portion of the sample in step (b) outside said intersection between said sample loading channel and said separation channel back to said corresponding sample reservoir and said sample waste reservoir by applying electric potentials, while the portion of the sample inside said intersection remains in said separation channel and other samples remain in their corresponding sample reservoirs; and
(d) electrophoretically separating the portion of the sample inside said intersection in step (c) by applying electric potentials to migrate the portion of the sample to said separation waste reservoir, while other samples remain in their corresponding sample reservoirs.

17. The method of claim 16, further comprising the step of repeating steps (b) to (d) for a second sample.

18. The microchip of claim 7, wherein said cross section has an area of from 1.0 mm² to 0.01 μm².

19. The microchip of claim 8, wherein said cross section has an area of from 1.0 mm² to 0.01 μm².
